(19) United States
(12) Patent Application Publication
(10) Pub. No.: US 2009/0153455 A1
(43) Pub. Date: Jun. 18, 2009

(54) GRAY INSERTION DEVICE AND LIQUID CRYSTAL DISPLAY

(75) Inventors: Wei-Kang Tsai, Hsinchu City (TW); Chin-Hung Hsu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/123,470

(22) Filed: May 20, 2008

(30) Foreign Application Priority Data
Dec. 17, 2007 (TW) 96148204

(51) Int. Cl. G09G 3/36

(52) U.S. Cl. 345/89

(57) ABSTRACT

A gray insertion device and a liquid crystal display (LCD) are provided. The gray insertion device is adapted to the LCD. The LCD includes a source driver and a source driving line. The gray insertion device includes a gray insertion controller and a gray insertion switch unit. The gray insertion switch unit is disposed outside the source driver. The gray insertion switch unit is coupled to the source driving line and the gray insertion controller. The gray insertion controller controls the gray insertion switch unit to transmit a voltage to the source driving line according to a timing signal, wherein the voltage is not provided by the source driver. Thereby, the present invention not only achieves gray insertion effect, but also decreases the power consumption of the source driver.

### CROSS-REFERENCE TO RELATED APPLICATION

This application claims the priority benefit of Taiwan application serial no. 96148204, filed on Dec. 17, 2007. The entirety of the above-mentioned patent application is hereby incorporated by reference herein and made a part of specification.

### BACKGROUND OF THE INVENTION

1. Field of the Invention

The present invention relates to a liquid crystal display, and particularly relates to a gray insertion technique of the liquid crystal display.

2. Description of Related Art

In recent years, liquid crystal displays (LCD) become popular and widely-used as the technology of semiconductor develops. However, the response speed of liquid crystal molecules is still not fast enough in the present day, and the problem of residual images often occurs when a liquid crystal display displays motion pictures. Such a phenomenon is called a motion blur by persons of ordinary knowledge in this art. Accordingly, a gray insertion technique (or called a black insertion technique) has been developed to overcome this problem. The following descriptions are accompanied with figures to further specify the conventional gray insertion technique.

FIG. 1 is a system configuration diagram of a conventional liquid crystal display. Referring to FIG. 1, a liquid crystal display 10 uses a timing controller 20 (T-con) to provide a timing signal TS1 and video data Data to a source driver 30. The timing controller 20 also provides a timing signal TS2 to a gate driver 40.

Generally speaking, the source driver 30 generates source driving signals SL_1˜SL_M (only SL_1˜SL_6 are shown in FIG. 1) according to the timing signal TS1 and the video data Data, and respectively transmits the source driving signals SL_1˜SL_M to the source terminals of transistors T(1,1)˜T(N,M) of a panel 50 through source driving lines S1˜SM (only SL_1˜SL_6 are shown in FIG. 1). Moreover, the source driver 30 generates a gray insertion signal GI according to the timing signal TS1, and transmits the gray insertion signal GI to the source terminals of transistors T(1,1)˜T(N,M) of the panel 50 through the source driving lines S1˜SM.

Meanwhile, the gate driver 40 sequentially generates gate driving signals GL_1˜GL_N (only GL_1˜GL_4 are shown in FIG. 1) according to the timing signal TS2, and respectively transmits the gate driving signals GL_1˜GL_N to the gate terminals of transistors T(1,1)˜T(N,M) of the panel 50 through gate driving lines L1˜LN (only L1˜L4 are shown in FIG. 1) for controlling whether the transistors T(1,1)˜T(N,M) is turned on or not.

By the coordination of the timing controller 20, the source driver 30, and the gate driver 40, pixels P(1,1)˜P(N,M) of the panel 50 can display a normal image (or called a video image) or a gray insertion image, wherein the pixel P(1,1) represents the pixel coupled to the gate driving line L1 and the source driving line S1, the pixel P(2,1) represents the pixel coupled to the gate driving line L2 and the source driving line S1, the pixel P(1,2) represents the pixel coupled to the gate driving line L1 and the source driving line S2, and so on.

First, an example based on the display of a normal image is explained. When a normal image is displayed, the gate driver 40 outputs a high-potential gate driving signal GL_1 to turn on the transistors T(1,1)˜T(1,M). Then, the source driver 30 outputs the source driving signals SL_1˜SL_M (i.e. the video data of the pixels in the first row of an normal image) to drive the pixels P(1,1)˜P(1,M) so as to complete scanning the pixels in the first row of the normal image.

Next, the gate driver 40 outputs a high-potential gate driving signal GL_2 to turn on the transistors T(2,1)˜T(2,M). Then, the source driver 30 outputs the source driving signals SL_1˜SL_M (i.e. the video data of the pixels in a second row of the normal image) to drive the pixels P(2,1)˜P(2,M) so as to complete scanning the pixels in the second row of the normal image. Accordingly, the pixels of each row in the normal image are sequentially scanned.

FIG. 2 is a schematic view of a conventional panel displaying a normal image and a gray insertion image. Referring to FIGS. 1 and 2 together, to overcome the problem of motion blur, the panel 50 displays a gray insertion image after displaying a normal image. The panel 50 displaying a gray insertion image is specified as the following paragraphs.

When a gray insertion image is displayed, the gate driver 40 outputs a high-potential gate driving signal GL_1 to turn on the transistors T(1,1)˜T(1,M). Then, the source driver 30 respectively transmits the gray insertion signal GI to the pixels P(1,1)˜P(1,M) so as to complete scanning the pixels in the first row of the gray insertion image.

Next, the gate driver 40 outputs a high-potential gate driving signal GL_2 to turn on the transistors T(2,1)˜T(2,M). Then, the source driver 30 respectively transmits the gray insertion signal GI to the pixels P(2,1)˜P(2,M) so as to complete scanning the pixels in the second row of the gray insertion image. Accordingly, the pixels of each row in the gray insertion image are sequentially scanned.

It is noted that if the panel 50 displays 30 normal images every second the panel 50 will need to display 30 normal images and 30 gray insertion images every second after a gray insertion image is added between every two normal images. In other words, if the source driver 30 is used to realize the aforesaid gray insertion technique, a frame rate of the liquid crystal display 10 needs to be doubled. However, such method will increase the power consumption, raise the temperature, and reduce the stability of the source driver 30.

### SUMMARY OF THE INVENTION

The present invention is directed to a gray insertion device, which not only achieves gray insertion effect but also decreases the power consumption of a source driver.

The present invention is directed to a liquid crystal display, which contains the gray insertion device to achieve the aforesaid gray insertion effect and further to solve the problem of residual images caused by motion blur.

The present invention provides a gray insertion device which is adapted to a liquid crystal display. The liquid crystal display includes a source driver and a source driving line, wherein the source driver is coupled to the source driving line. The gray insertion device comprises a gray insertion controller and a gray insertion switch unit. The gray insertion switch unit is disposed outside the source driver and is coupled to the source driving line. The gray insertion controller is coupled to the gray insertion switch unit. The gray insertion controller controls the gray insertion switch unit to transmit a voltage to the source driving line according to a timing signal, wherein the voltage is provided from an external voltage outside the source driver.

In an embodiment of the present invention, the gray insertion switch unit comprises a first switch and a second switch. The first switch is coupled to the source driving line and transmits the voltage to the source driving line in a first period. The second switch is coupled to the source driving line and transmits a second voltage to the source driving line in a second period.

In an embodiment of the present invention, the liquid crystal display further comprises a second source driving line. In addition, the gray insertion switch unit comprises the first switch and the second switch. The first switch is coupled to the source driving line and transmits the voltage to the source driving line in a period. The second switch is coupled to the second source driving line and transmits a second voltage to the second source driving line in the period. In another embodiment of the present invention, the gray insertion switch unit further comprises a third switch and a fourth switch. The third switch is coupled to the source driving line and transmits the second voltage to the source driving line in a second period. The fourth switch is coupled to the second source driving line and transmits the voltage to the second source driving line in the second period.

In an embodiment of the present invention, the timing signal comprises a gray insertion enabling signal. When the gray insertion enabling signal is disabled, the gray insertion controller turns off the gray insertion switch unit; and when the gray insertion enabling is enabled, the gray insertion controller maintains the operation of the gray insertion switch unit. In another embodiment, the external voltage is provided by a system power supplier.

In an embodiment of the present invention, the gray insertion controller is disposed in the timing controller of the liquid crystal display, in the gate driver of the liquid crystal display, in a non-display area of the panel of the liquid crystal display, or in the source driver. In another embodiment, the gray insertion switch unit is disposed on the non-display area of the panel of the liquid crystal display.

The present invention also provides a liquid crystal display which contains the above-mentioned gray insertion device to achieve the aforesaid gray insertion effect, and meanwhile prevents the problem of residual images caused by motion blur.

The gray insertion controller of the present invention controls the gray insertion switch unit to transmit a voltage outside the source driver to the source driving line according to the timing signal, which replaces the conventional gray insertion signal generated by the source driver. Therefore, the gray insertion effect can be achieved by the present invention, and further the power consumption of the source driver also can be reduced by the present invention.

To make the aforesaid features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system configuration diagram of a conventional liquid crystal display.

FIG. 2 is a schematic view of a conventional panel displaying a normal image and a gray insertion image.

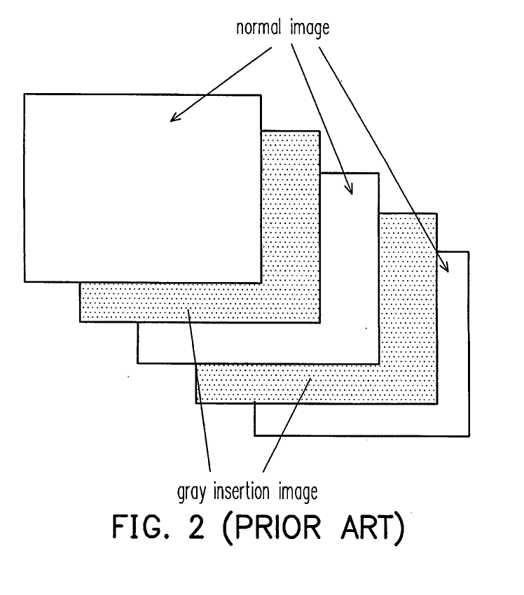

FIG. 3 is a system configuration diagram of a liquid crystal display according to the first embodiment of the present invention.

FIG. 4 is a portion of a sequence diagram showing the signals described in the first embodiment of the present invention.

FIG. 5 is a system configuration diagram of a liquid crystal display according to the second embodiment of the present invention.

FIG. 6 is a system configuration diagram of a liquid crystal display according to the third, the fourth, and the fifth embodiments of the present invention.

FIG. 7 is a portion of a sequence diagram showing the signals described in the fifth embodiment of the present invention.

### DESCRIPTION OF EMBODIMENTS

### First Embodiment

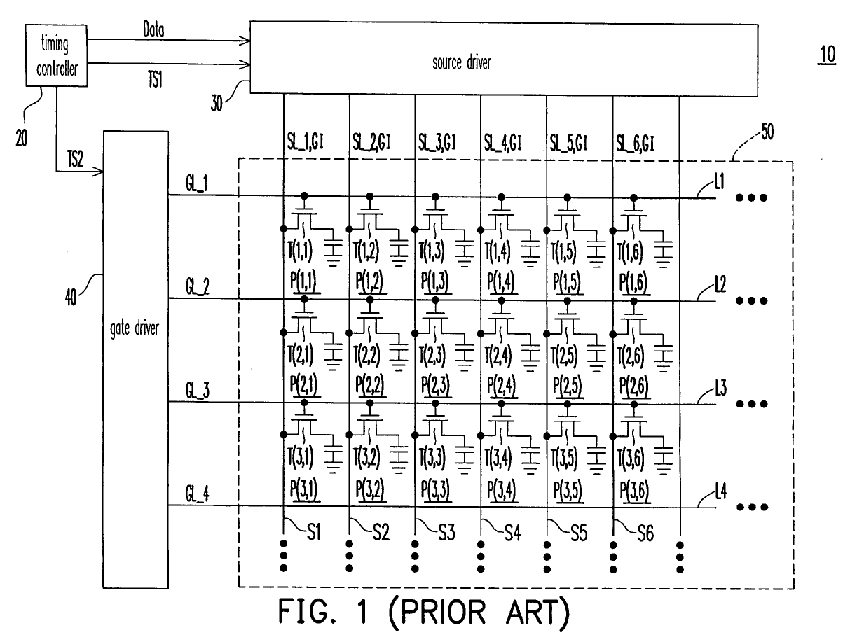

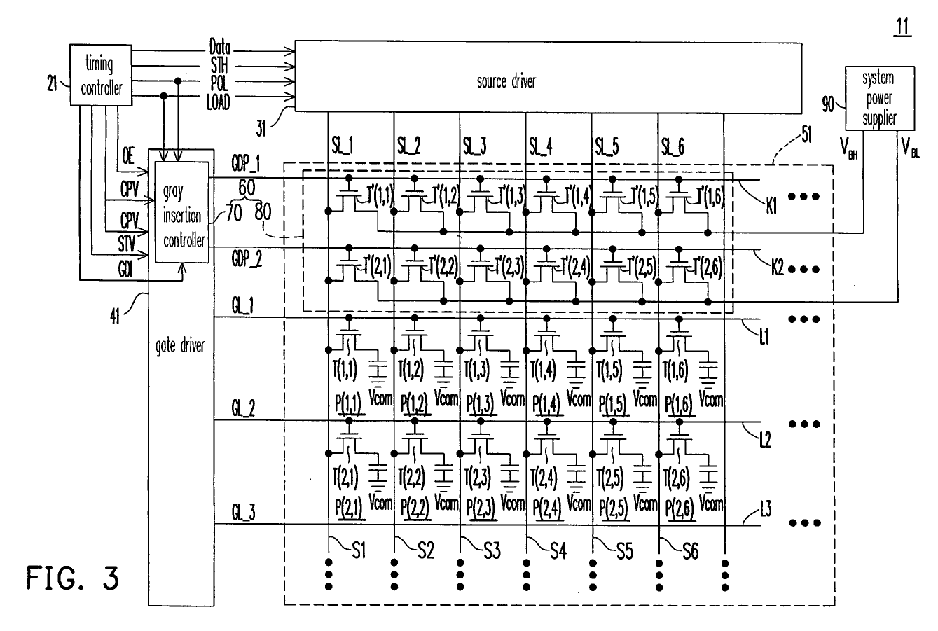

FIG. 3 is a system configuration diagram of a liquid crystal display according to the first embodiment of the present invention. Referring to FIG. 3, a liquid crystal display 11 comprises a timing controller 21, a source driver 31, a gate driver 41, a panel 51, a system power supplier 90, source driving lines S1˜SM (only S1˜S6 are shown in FIG. 3), gate driving lines L1˜LN (only L1˜L3 are shown in FIG. 3), and a gray insertion device 60, wherein M and N represent natural numbers. In this embodiment, a conventional gray insertion signal GI provided by the source driver 30 in FIG. 1 is replaced by a voltage provided by the system power supplier 90, and the voltage is represented by V_{BH} or V_{BL} in the following descriptions. In this embodiment, (V_{BH}+V_{BL})/2 is assumed to be equal to a common voltage V_{com}. The gray insertion device 60 comprises a gray insertion controller 70 and a gray insertion switch unit 80.

The gray insertion switch unit 80 may be disposed outside the source driver 31, for example, in a non-display area of the panel 51. The gray insertion switch unit 80 is coupled to the source driving lines S1˜SM and the gray insertion controller 70. In this embodiment, the gray insertion switch unit 80 comprises, for example, switches T′(1,1)˜T′(1,M) and switches T′(2,1)˜T′(2,M), which are realized by N-type transistors. Gate terminals of the switches T′(1,1)˜T′(1,M) are coupled to a control line K1, and drain terminals of the switches T′(1,1)˜T′(1,M) are respectively coupled to the source driving lines S1˜SM. Source terminals of the switches T′(1,1)˜T′(1,M) are used to receive the voltage V_{BH}. Gate terminals of the switches T′(2,1)˜T′(2,M) are coupled to a control line K2, and drain terminals of the switches T′(2,1)˜T′(2,M) are respectively coupled to the source driving lines S1˜SM. Source terminals of the switches T′(2,1)˜T′(2,M) are used to receive the voltage V_{BL}.

The panel 51 comprises pixels P(1,1)˜P(N,M), wherein the pixel P(1,1) represents the pixel coupled to the gate driving line L1 and the source driving line S1, the pixel P(2,1) represents the pixel coupled to the gate driving line L2 and the source driving line S1, the pixel P(1,2) represents the pixel coupled to the gate driving line L1 and the source driving line S2, and so on. In addition, transistors T(1,1)˜T(N,M) respectively represent the switches of the pixels P(1,1) P(N,M).

In this embodiment, the timing signal comprises, for example, a horizontal synchronous initial signal STH, a vertical synchronous initial signal STV, a loading signal LOAD, a polarity inversion signal POL, a gray insertion enabling signal GDI, a basic clock CPV, and a gate control signal OE.

The source driver 31 generates source driving signals SL_1˜SL_M (only SL_1˜SL_6 are shown in FIG. 3) according to the horizontal synchronous initial signal STH, the polarity inversion signal POL, the loading signal LOAD, and video data, and then respectively transmits the source driving signals SL_1˜SL_M to the source terminals of transistors T(1,1)˜T(N,M) of the panel 51 through the source driving lines S1˜SM.

In addition, the gate driver 41 sequentially generates gate driving signals GL_1˜GL_N according to the vertical synchronous initial signal STV and the gate control signal OE, and then respectively transmits the gate driving signals GL_1˜GL_N (only GL_1˜GL_3 are shown in FIG. 3) to the gate terminals of transistors T(1,1)˜T(N,M) of the panel 51 through the gate driving lines L1˜LN so as to turn on or turn off transistors T(1,1)˜T(N,M).

The gray insertion controller 70 generates a gray insertion control signal GDP_1 and a gray insertion control signal GDP_2 according to the loading signal LOAD, the polarity inversion signal POL, the gray insertion enabling signal GDI, and the basic clock CPV. Specifically, when the gray insertion enabling signal GDI is disabled, for example, a low-potential voltage, the gray insertion controller 70 outputs the low-potential GDP_1 and GDP_2 to turn off the gray insertion switch unit 80. When the gray insertion enabling signal GDI is enabled, for example, a high-potential voltage, the gray insertion controller 70 generates the gray insertion control signals GDP_1 and GDP_2 according to the loading signal LOAD, the polarity inversion signal POL, and the basic clock CPV to maintain the operation of the gray insertion switch unit 80. The gray insertion control signal GDP_1 determines the turn-on and turn-off of the switches T′(1,1)˜T′(1,M) so as to control whether the voltage V_{BH} provided by the system power supplier 90 is transmitted to the source driving lines S1˜SM or not. The gray insertion control signal GDP_2 determines the turn-on and turn-off of the switches T′(2,1)˜T′(2,M) so as to control whether the voltage V_{BL} provided by the system power supplier 90 is transmitted to the source driving lines S1˜SM or not.

By the coordination of the timing controller 21, the source driver 31, the gate driver 41, and the gray insertion controller 70, the pixels P(1,1)˜P(N,M) of the panel 51 can display a normal image or a gray insertion image.

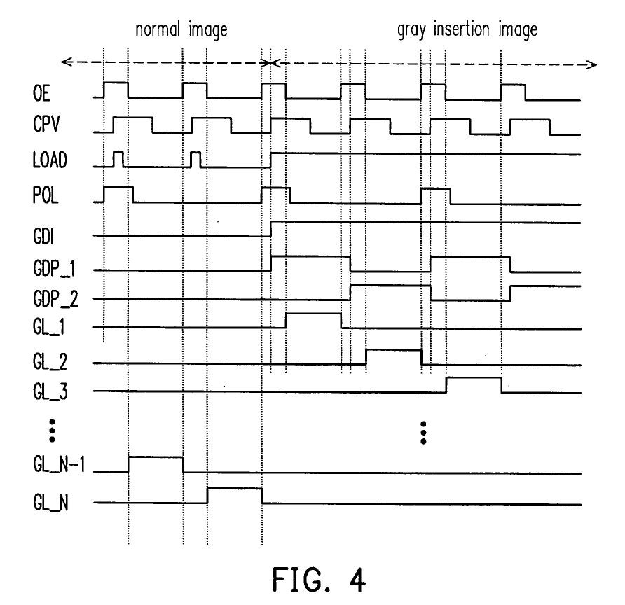

FIG. 4 is a portion of a sequence diagram showing the signals described in the first embodiment of the present invention. Referring to FIGS. 3 and 4 together, the display of a normal image is provided as an example. When a normal image is displayed, the gate driver 41 outputs the high-potential gate driving signal GL_1 to turn on the transistors T(1,1)˜T(1,M). Then, the source driver 31 outputs the source driving signals SL_1˜SL_M, i.e. the video data of the pixels in the first row pixel of the normal image, to drive the pixels P(1,1)˜P(1,M) so as to complete scanning the pixels in the first row of the normal image.

Thereafter, the gate driver 41 outputs a high-potential gate driving signal GL_2 to turn on the transistors T(2,1)˜T(2,M). The source driver 31 then outputs the source driving signals SL_μL_M, i.e. the video data of the pixels in the second row of the normal image, to drive the pixels P(2,1)˜P(2,M) so as to complete scanning the pixels in the second row of the normal image. Accordingly, the pixels in each row of the normal image are sequentially scanned.

To overcome the problem of residual images caused by motion blur, the panel 51 displays a gray insertion image after displaying a normal image. The panel 51 displaying a gray insertion image is specified as follows.

In this embodiment, the technique of polarity inversion is specified by the example of row inversion. When a gray insertion image is displayed, the gate driver 41 outputs the high-potential gate driving signal GL_1 to turn on the transistors T(1,1)˜T(1,M). Then, the gray insertion controller 70 outputs the high-potential gray insertion control signal GDP_1 to turn on the switches T′(1,1)˜T′(1,M). Consequently, the system power supplier 90 transmits the high-potential voltage V_{BH} to the pixels P(1,1)˜P(1,M) so as to complete scanning the pixels in the first row of the gray insertion image.

Thereafter, the gate driver 41 outputs the high-potential gate driving signal GL_2 to turn on the transistors T(2,1)˜T(2,M). The gray insertion controller 70 then outputs the high-potential gray insertion control signal GDP_2 to turn on the switches T′(2,1)˜T′(2,M). Consequently, the system power supplier 90 transmits the low-potential voltage V_{BL} to the pixels P(2,1)˜P(2,M) so as to complete scanning the pixels in the second row of the gray insertion image.

Thereafter, the gate driver 41 outputs a high-potential gate driving signal GL_3 to turn on the transistors T(3,1)˜T(3,M). The gray insertion controller 70 then outputs the high-potential gray insertion control signal GDP_1 to turn on the switches T′(1,1)˜T′(1,M). Consequently, the system power supplier 90 transmits the high-potential voltage V_{BH} to the pixels P(3, 1)˜P(3,M) so as to complete scanning the pixels in the third row of the gray insertion image. Accordingly, the pixels in each row of the gray insertion image are sequentially scanned. Persons skilled in this art may refer to the following table for the processes described in the first embodiment.

TABLE 1
Sequence of Processes in the First Embodiment

| Sequence | Process |
|---|---|
| First Period | The pixels coupled to the gate driving line GL_1 display a normal image. |
| Second Period | The pixels coupled to the gate driving line GL_2 display a normal image. |
| . | . |
| . | . |
| . | . |
| N Period | The pixels coupled to the gate driving line GL_N display a normal image. |
| N + 1 Period | The pixels coupled to the gate driving line GL_1 display a gray |
| | insertion image. |
| N + 2 Period | The pixels coupled to the gate driving line GL_2 display a gray |
| | insertion image. |
| . | . |
| . | . |
| . | . |
| 2N Period | The pixels coupled to the gate driving line GL_N display a gray |
| | insertion image. |
| 2N + 1 Period | The pixels coupled to the gate driving line GL_1 display a normal image. |
| 2N + 2 Period | The pixels coupled to the gate driving line GL_2 display a normal image. |
| . | . |
| . | . |
| . | . |

It is noted that this embodiment uses the gray insertion controller 70 to control the gray insertion switch unit 80 to transmit the voltages (i.e. V_{BH} and V_{BL}) provided by the system power supplier 90 to the source driving lines S1˜SM so as to display a gray insertion image. In other words, this embodiment replaces a conventional gray insertion signal GI generated by the source driver 30 in FIG. 1 with the voltage provided by the power supplier 90. Hence, the gray insertion effect is achieved, and the power consumption of the source driver 31 is reduced.

Although the above embodiment has disclosed a possible type of a liquid crystal display and a gray insertion device, it is common sense to persons of ordinary knowledge in this art that different manufacturers may develop different designs of liquid crystal displays and gray insertion devices, and the application of the present invention should not be limited to this type only. It is to say the spirit of the present invention lies in that the conventional gray insertion signal generated by the source driver is replaced by the process that the gray insertion controller controls the gray insertion switch unit to transmit the voltage outside the source driver to the source driving line according to the timing signal. To further explain the spirit of the present invention to persons of ordinary knowledge in this art, several embodiments are detailed in the following paragraphs.

Referring to FIG. 3, although the gray insertion controller 70 is disposed in the gate driver 41 according to the first embodiment, the present invention is not limited thereto. Persons skilled in this art may dispose the gray insertion controller 70 in the source driver 31, in the timing controller 21, in a non-display area of the panel 51, or even in an individual area of the display system to meet their requirements. Furthermore, in the first embodiment, the timing controller 21 may disable the source driver 31 when the panel 51 displays a gray insertion image, and then enable the source driver 31 when the panel 51 begins displaying a normal image. Thereby, the power consumption of the source driver 31 is further reduced.

Although the first embodiment is explained by the technique of row inversion, persons skilled in this art may adopt other polarity inversion techniques according to their requirements. Several embodiments are detailed in the following paragraphs.

### Second Embodiment

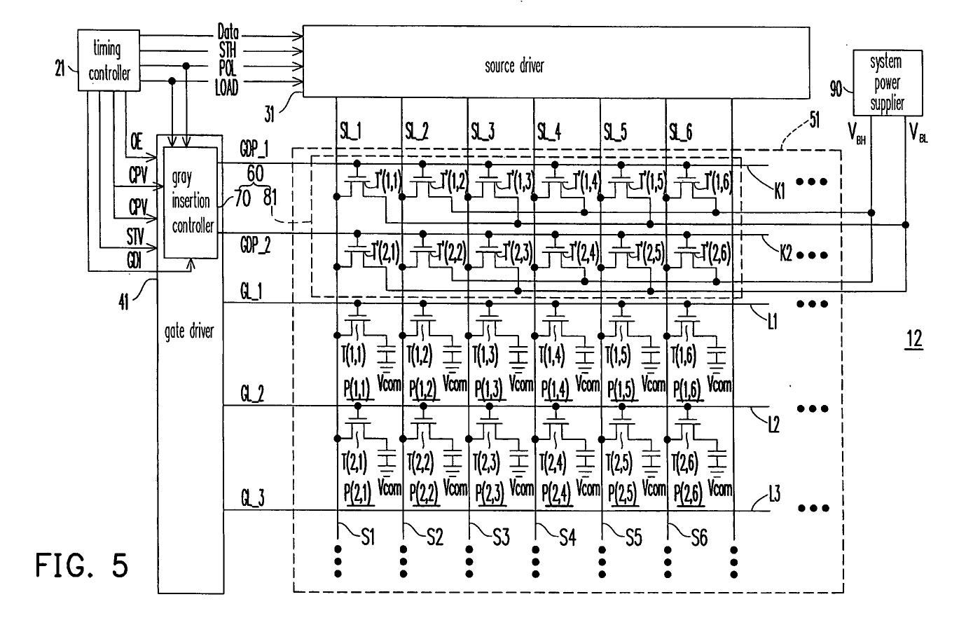

FIG. 5 is a system configuration diagram of a liquid crystal display according to the second embodiment of the present invention. Referring to FIGS. 3 and 5 together, a liquid crystal display 12 in FIG. 5 is similar to the liquid crystal display 11 in FIG. 3. Please refer to the first embodiment for the identical reference numerals in FIG. 5 and FIG. 3. Referring to the gray insertion switch unit 81 in FIG. 5, it is worth noticing that the source terminals of the switches T′(1,1), T′(1,3), T′(1,5) . . . are coupled to the voltage V_{BH} of the system power supplier 90. The source terminals of the switches T′(1,2), T′(1,4), T′(1,6) . . . are coupled to the voltage V_{BL} of the system power supplier 90. The source terminals of the switches T′(2,1), T′(2,3), T′(2,5) . . . are coupled to the voltage V_{BL} of the system power supplier 90. The source terminals of the switches T′(2,2), T′(2,4), T′(2,6) . . . are coupled to the voltage V_{BH} of the system power supplier 90. The advantage of this method lies in that the technique of dot inversion is realized to improve the image quality of the liquid crystal display 11 when a normal image is display.

In this embodiment, when a gray insertion image is displayed, the gate driver 41 outputs the high-potential gate driving signal GL_1 to turn on the transistors T(1,1)˜T(1,M). Then, the gray insertion controller 70 outputs the high-potential gray insertion control signal GDP_1 to turn on the switches T′(1,1)˜T′(1,M). Consequently, the pixels P(1,1), P(1,3), P(1,5) . . . receive the high-potential voltage V_{BH}, and the pixels P(1,2), P(1,4), P(1,6) . . . receive the low-potential voltage V_{BL} to complete scanning the pixels in the first row of the gray insertion image.

Thereafter, the gate driver 41 outputs the high-potential gate driving signal GL_2 to turn on the transistors T(2,1)˜T(2,M). The gray insertion controller 70 then outputs the high-potential gray insertion control signal GDP_2 to turn on the switches T′(2,1)˜T′(2,M). As a result, the pixels P(2,1), P(2,3), P(2,5) . . . receive the low-potential voltage V_{BL} and the pixels P(2,2), P(2,4), P(2,6) . . . receive the high-potential voltage V_{BH} to complete scanning the pixels in the second row of the gray insertion image.

Thereafter, the gate driver 41 outputs the high-potential gate driving signal GL_3 to turn on the transistors T(3,1)˜T(3,M). The gray insertion controller 70 then outputs the high-potential gray insertion control signal GDP_1 to turn on the switches T′(1,1)˜T′(1,M). Consequently, the pixels P(3,1), P(3,3), P(3,5) . . . receive the high-potential voltage V_{BH} and the pixels P(3,2), P(3,4), P(3,6) . . . receive the low-potential voltage V_{BL} to complete scanning the pixels in the third row of the gray insertion image. Accordingly, the pixels in each row of the gray insertion image are sequentially scanned. The technique of dot inversion is thereby realized.

### Third Embodiment

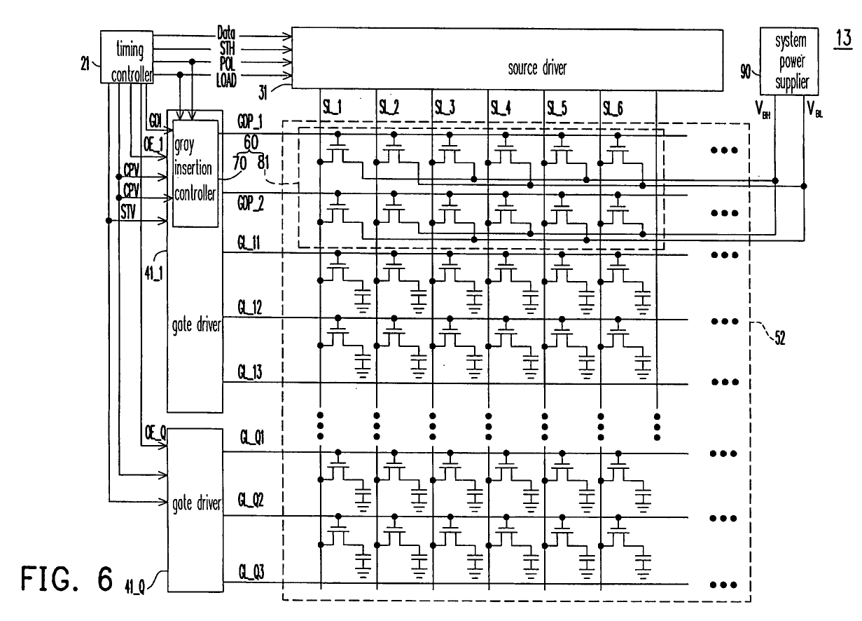

Persons skilled in this art may also vary the structure of the liquid crystal display to meet their requirements. For instance, FIG. 6 is a system configuration diagram of a liquid crystal display according to the third, the fourth, and the fifth embodiments of the present invention. Referring to FIG. 5 and FIG. 6, FIG. 5 is similar to FIG. 6. Please refer to the previous embodiments for the identical reference numerals shown in FIG. 5 and FIG. 6. It is worth noticing that the liquid crystal display 13 has a plurality of gate drivers. This embodiment is specified based on the example of Q gate drivers (the gate drivers are represented by 41_1˜41_Q), wherein Q is a natural number.

To be more specific, the gate driver 41_1 generates gate driving signals GL_11˜GL_1N according to the vertical synchronous initial signal STV, the basic clock CPV, and the gate control signal OE_1 so as to control the pixels in N row of the panel 52. Accordingly, the gate driver 41_Q generates gate driving signals GL_Q1˜GL_QN according to the vertical synchronous initial signal STV, the basic clock CPV, and the gate control signal OE_Q so as to control the pixels in N row of the panel 52. The advantage of this method lies in that the use of a plurality of gate drivers effectively realizes the gray insertion technique in a large-size panel.

### Fourth Embodiment

Persons skilled in this art may also vary the gray insertion technique to meet their requirements. For instance, the panel in the first embodiment displays a gray insertion image after displaying a normal image. However, in other embodiments, the panel may be changed to display a row of pixels in a gray insertion image after displaying a row of pixels in a normal image, as shown in Table 2. Referring to FIG. 6 together with Table 2, the panel 52 has, for example, Q×N rows of pixels, wherein Q and N are natural numbers. The advantage of this method lies in that the panel 52 displays images more uniformly.

TABLE 2
Sequence of Processes in the Fourth Embodiment

| Sequence | Process |
|---|---|
| First Period | The pixels coupled to the gate driving line GL_11 |
| | display a normal image. |
| Second Period | The pixels coupled to the gate driving line GL_Q1 |
| | display a gray insertion image. |
| Third Period | The pixels coupled to the gate driving line GL_12 |
| | display a normal image. |
| Fourth Period | The pixels coupled to the gate driving line GL_Q2 |
| | display a gray insertion image. |
| . | . |
| . | . |
| . | . |
| 2(N − 1) + 1 Period | The pixels coupled to the gate driving line GL_1N |
| | display a normal image. |
| 2(N) Period | The pixels coupled to the gate driving line GL_QN |
| | display a gray insertion image. |
| 2(N) + 1 Period | The pixels coupled to the gate driving line GL_21 |
| | display a normal image. |
| 2(N + 1) Period | The pixels coupled to the gate driving line GL_11 |
| | display a gray insertion image. |
| . | . |
| . | . |
| . | . |

### The Fifth Embodiment

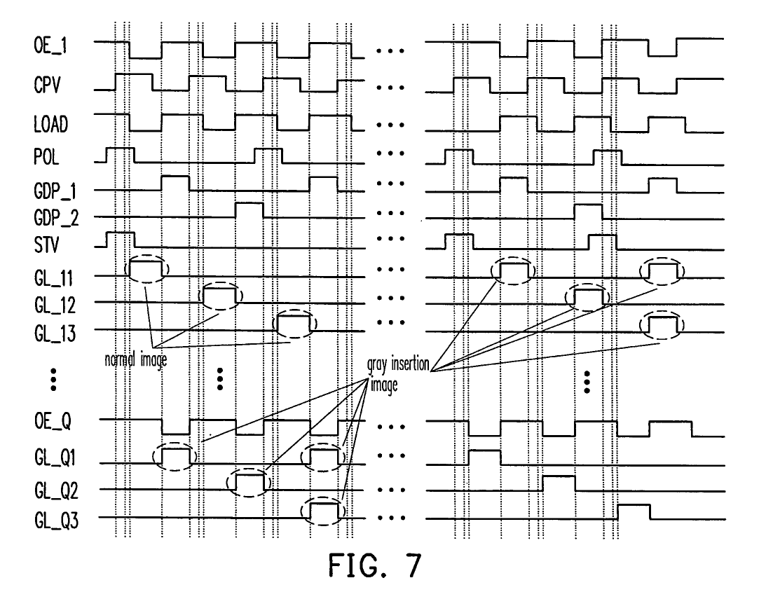

Moreover, in other embodiments, the panel may display a plurality of rows of pixels in a gray insertion image after displaying a row of pixels in a normal image, as shown in Table 3. FIG. 7 is a portion of a sequence diagram showing the signals described in the fifth embodiment of the present invention. Referring to FIG. 6 and FIG. 7 together with Table 3, the panel 52 has, for example, Q×N rows of pixels, wherein Q and N are natural numbers. The advantage of this method lies in that the gray insertion image is enhanced.

TABLE 3
Sequence of Processes in the Fifth Embodiment

| Sequence | Process |
|---|---|
| First Period | The pixels coupled to the gate driving line GL_11 |
| | display a normal image. |
| Second Period | The pixels coupled to the gate driving lines |
| | GL_(Q − 1)(N − 3), GL_(Q − 1)(N − 1), and GL_Q1 display a |
| | gray insertion image. |
| Third Period | The pixels coupled to the gate driving line GL_12 |
| | display a normal image. |
| Fourth Period | The pixels coupled to the gate driving lines |
| | GL_(Q − 1)(N − 2), GL_(Q − 1)N, and GL_Q2 display a gray |
| | insertion image. |
| Fifth Period | The pixels coupled to the gate driving line GL_13 |
| | display a normal image. |
| Sixth Period | The pixels coupled to the gate driving lines |
| | GL_(Q − 1)(N − 1), GL_Q1, and GL_Q3 display a gray |
| | insertion image. |
| Seventh Period | The pixels coupled to the gate driving line GL_14 |
| | display a normal image. |
| Eighth Period | The pixels coupled to the gate driving lines GL_(Q − 1)N, |
| | GL_Q2, and GL_Q4 display a gray insertion image. |
| Ninth Period | The pixels coupled to the gate driving line GL_15 |
| | display a normal image. |
| Tenth Period | The pixels coupled to the gate driving lines GL_Q1, |
| | GL_Q3, and GL_Q5 display a gray insertion image. |
| Eleventh Period | The pixels coupled to the gate driving line GL_16 |
| | display a normal image. |
| Twelfth Period | The pixels coupled to the gate driving lines GL_Q2, |
| | GL_Q4, and GL_Q6 display a gray insertion image. |
| . | . |
| . | . |
| . | . |
| 2(N − 1) + 1 Period | The pixels coupled to the gate driving line GL_1N |
| | display a normal image. |
| 2(N) Period | The pixels coupled to the gate driving lines GL_Q(N − 4), |
| | GL_Q(N − 2) and GL_QN display a gray insertion image. |
| 2(N) + 1 Period | The pixels coupled to the gate driving line GL_21 |
| | display a normal image. |
| 2(N + 1) Period | The pixels coupled to the gate driving lines GL_Q(N − 3), |
| | GL_Q(N − 1) and GL_11 display a gray insertion image. |
| . | . |
| . | . |
| . | . |

In summary, the gray insertion controller of the present invention controls the gray insertion switch unit to transmit the voltage outside the source driver to the source driving line according to the timing signal, which replaces the conventional gray insertion signal generated by the source driver. Hence, the gray insertion effect is achieved, and the power consumption of the source driver is reduced. In addition, the embodiment of the present invention has at least the following advantages:
1. The aforesaid gray insertion device is adapted to alternately displaying a normal image and a gray insertion image so as to overcome the problem of residual images.
2. The aforesaid gray insertion device is adapted to alternately displaying a row of pixels in a normal image and a row of pixels in a gray insertion image. The advantage of this method lies in that the panel displays images more uniformly.
3. The aforesaid gray insertion device is adapted to alternately displaying a row of pixels in a normal image and a plurality of rows of pixels in a gray insertion image. The advantage of this method lies in that the gray insertion effect is enhanced.
4. The aforesaid gray insertion device is adapted to various polarity inversion techniques, such as row inversion, column inversion, dot inversion, multi-row or multi-column inversion, and so on.

Although the present invention has been disclosed by the above embodiments, they are not intended to limit the present invention. Anybody skilled in this art can make modifications and variations without departing from the spirit and scope of the present invention. Therefore, the protection range of the present invention falls in the appended claims.

What is claimed is:

1. A gray insertion device, adapted to a liquid crystal display, the liquid crystal display comprising a source driver and a source driving line coupled to the source driver, the gray insertion device comprising:
a gray insertion switch unit, disposed outside the source driver and coupled to the source driving line; and
a gray insertion controller, coupled to the gray insertion switch unit and used for controlling the gray insertion switch unit to transmit a voltage to the source driving line according to a timing signal, wherein the voltage is provided from an external voltage outside the source driver.

2. The gray insertion device as claimed in claim 1, wherein the gray insertion switch unit comprises:
a first switch, coupled to the source driving line and used for transmitting the voltage to the source driving line in a first period; and
a second switch, coupled to the source driving line and used for transmitting a second voltage to the source driving line in a second period.

3. The gray insertion device as claimed in claim 1, wherein the liquid crystal display further comprises a second source driving line, and the gray insertion switch unit comprises:
a first switch, coupled to the source driving line and used for transmitting the voltage to the source driving line in a period; and
a second switch, coupled to the second source driving line and used for transmitting a second voltage to the second source driving line in the period.

4. The gray insertion device as claimed in claim 3, wherein the gray insertion switch unit further comprises:
a third switch, coupled to the source driving line and used for transmitting the second voltage to the source driving line in a second period; and
a fourth switch, coupled to the second source driving line and used for transmitting the voltage to the second source driving line in the second period.

5. The gray insertion device as claimed in claim 1, wherein the timing signal comprises a gray insertion enabling signal, and when the gray insertion enabling signal is disabled, the gray insertion controller turns off the gray insertion switch unit; when the gray insertion enabling signal is enabled, the gray insertion controller maintains the operation of the gray insertion switch unit.

6. The gray insertion device as claimed in claim 1, wherein the external voltage is provided by a system power supplier.

7. The gray insertion device as claimed in claim 1, wherein the gray insertion controller is disposed in a timing controller of the liquid crystal display, in a gate driver of the liquid crystal display, in a non-display area of a panel of the liquid crystal display, or in the source driver.

8. The gray insertion device as claimed in claim 1, wherein the gray insertion switch unit is disposed on a non-display area of a panel of the liquid crystal display.

9. A liquid crystal display, comprising:
a source driver;
a source driving line, coupled to the source driver;
a gray insertion switch unit, disposed outside the source driver and coupled to the source driving line; and
a gray insertion controller, coupled to the gray insertion switch unit and used for controlling the gray insertion switch unit to transmit a voltage to the source driving line according to a timing signal, wherein the voltage is provided from an external voltage outside the source driver.

10. The liquid crystal display as claimed in claim 9, wherein the gray insertion switch unit comprises:
a first switch, coupled to the source driving line and used for transmitting the voltage to the source driving line in a first period; and
a second switch, coupled to the source driving line and used for transmitting a second voltage to the source driving line in a second period.

11. The liquid crystal display as claimed in claim 9, wherein the liquid crystal display further comprises a second source driving line, and the gray insertion switch unit comprises:
a first switch, coupled to the source driving line and used for transmitting the voltage to the source driving line in a period; and
a second switch, coupled to the second source driving line and used for transmitting a second voltage to the second source driving line in the period.

12. The liquid crystal display as claimed in claim 11, wherein the gray insertion switch unit further comprises:
a third switch, coupled to the source driving line and used for transmitting the second voltage to the source driving line in a second period; and
a fourth switch, coupled to the second source driving line and used for transmitting the voltage to the second source driving line in the second period.

13. The liquid crystal display as claimed in claim 9, wherein the timing signal comprises a gray insertion enabling signal, and when the gray insertion enabling signal is disabled, the gray insertion controller turns off the gray insertion switch unit; when the gray insertion enabling signal is enabled, the gray insertion controller maintains the operation of the gray insertion switch unit.

14. The liquid crystal display as claimed in claim 9, further comprising:
a system power supplier, coupled to the gray insertion switch unit for supplying the external voltage to the gray insertion switch unit.

15. The liquid crystal display as claimed in claim 9, further comprising:
a timing controller, coupled to the source driver and the gray insertion controller for providing the timing signal;
a gate driver, coupled to the timing controller;
a gate driving line, coupled to the gate driver; and
a panel, coupled to the source driving line and the gate driving line, wherein the gray insertion controller is disposed in the timing controller, in the gate driver, in a non-display area of the panel or in the source driver; the gray insertion switch unit is disposed on a non-display area of the panel.
